(19) United States
(12) Patent Application Publication
(10) Pub. No.: US 2012/0180587 A1
(43) Pub. Date: Jul. 19, 2012

(54) MULTI STAGE SYSTEM FOR MODULAR TRANSMISSIONS

(76) Inventors: William Bruce Morrow, Santa Barbara, CA (US); David Kenneth Neidig, Plymouth, IN (US)

(21) Appl. No.: 13/008,205

(22) Filed: Jan. 18, 2011

(51) Int. Cl. F16H 1/08

(52) U.S. Cl. 74/414

(57) ABSTRACT

A transmission capable of receiving rotational power from the source on the surface of the earth and transmitting it to a tool down hole, comprising two or more modules, each of which is constructed of gear pairs held in a supporting structure and operatively engaged with an even number of gear pairs to provide the necessary power to the tool which the transmission drives.

The present invention relates to load sharing transmissions and, more particularly, to such transmissions assembled from a plurality of modular transmission elements to meet the specific needs of the well being, or to be, pumped.

### BACKGROUND OF THE INVENTION

1. Field of the Invention

The environment in which the present invention has particular, although perhaps not exclusive, utility, is in the area of production of oil and water from wells via a pump, most often a centrifugal pump, driven from the surface by a rotating rod string and speed increasing transmission located down hole (Deep Well Pumping Apparatus, Morris, U.S. Pat. No. 5,573,063.) In particular, the present invention concerns the construction of specialized transmissions built from modules said down hole transmissions.

2. Overview of the Prior Art

The inventor has been intimately engaged on the oil patch for several years and throughout the world and is a recognized expert. He is the holder of several patents in the field of down hole transmissions and particularly multi path load balancing and sharing transmissions, among them Morrow U.S. Pat. No. 5,573,063 relating to a down hole transmission for driving a pump; Morrow U.S. Pat. No. 5,927,147 teaching an early version of a load sharing gear set; Morrow U.S. Pat. No. 6,334,368 relating to a direct drive transmission capable of transmitting large loads relative to its size; Morrow U.S. Pat. No. 6,374,689 relating to a lever system for assisting in the balancing of loads in gear set, and Morrow U.S. Pat. No. 6,619,157 relating to a fluid system for balancing loads on a gear set.

There are additional applications currently pending which bear, generally, on the subject matter of this application. None of these efforts, however, transgress on the novelty of the present invention.

### SUMMARY OF THE INVENTION

The present invention addresses several needs common to the deep well industry, among them, the ability to adapt a down hole transmission to handle the varying loading needs. Further, it addresses methods of manufacturing and assembly of multi stage modular transmission elements indigenous to a functioning system of load sharing elements.

That said, it is an objective of the present invention to provide the industry with a transmission system which is adaptable to the specific loads which are to be experienced in performing a specific task. Yet another and somewhat more specific objective of the present invention is to provide a down hole transmission which is capable of transmitting significantly greater loads, while maintaining the dimensional parameters required by its environment.

It is a further objective to provide a quantity of substantially identical gear sets as modules which may be readily assembled into a down hole transmission capable of delivering the requisite loads required to drive a down hole pump. By using this type of construction, significant savings can be realized while increasing the capacity of the transmission.

The foregoing, as well as other objects and advantages will occur to those skilled in the art when the following Description of a Preferred Embodiment is read in conjunction with the drawings wherein;

### BRIEF DESCRIPTION OF THE DRAWINGS

FIG. 1 is a pictorial representation of a dual helical gear set module shown in side elevation;

FIG. 2 is a an exemplary gear train of a type which may be used in constructing a transmission in accordance with the present invention with a portion of the supporting structure sectioned to permit a view of the inner structure;

FIG. 3 is an illustration of the interrelationship between a representative gear pair, sectioned to show the central bores, which make up a portion of the dual gear module of FIG. 2;

FIG. 4 is a diagram of the gear pairs relationship with the supporting structure stripped away, and further used to illustrate the directional movement of the various elements of a gear set in rotational movement;

FIG. 5 is a gear set employing two modules as shown in FIG. 2;

FIG. 6 is a view similar to that of FIG. 1, but illustrating a different module which is usable in the construction of the present invention;

FIG. 7 is a side elevation of the drive shaft which is part of the FIG. 6 module;

FIG. 8 is a side elevation of the driven shaft which is part of the FIG. 6 module;

FIG. 9 is view similar to that of FIG. 3, although specifically configured to be part of a gear pair constructed to be part of the FIG. 6 module; and,

FIG. 10 is a gear train comprised of a pair of FIG. 6 modules.

### DETAILED DESCRIPTION OF A PREFERRED EMBODIMENT

Preliminarily, and as a means of enhancing one's understanding of the principals which define this application, the environment in which the transmission of the present invention has particular, although not exclusive, utility, is below the surface of the earth and as part of a deep well pumping apparatus having an exterior diameter of as little as 4 inches.

The transmission is called upon to drive, e.g., a pump, preferably centrifugal, which is attached to the transmission, from a power source at the earth's surface to several hundred to several thousand feet down a well shaft. The space in which the transmission operates necessarily places severe constraints on the usable loads it can transmit, thus requiring some innovative approach to the problems faced.

A recognized principal feature of the present invention is the ability to stack, or otherwise conjoin, in serial operative relation, like modular gear sets into a unitary load sharing gear train capable of delivering the needed loads to the tool at the end of the drill string.

Morrow (U.S. Pat. No. 5,927,147) has taught the industry various ways that loads may be shared through the use of helical gear pairs and, further, has demonstrated that the capacity of a given gear train can be materially enhanced by adding gear pairs to the gear train. However, it has also been shown that by simply adding gear pairs on an elongated shaft, complications arise which militate against the practical use of such techniques.

It should also be kept in mind that the transmission is an integral part of the apparatus and is, itself, typically several thousand feet below the surface, and if it should fail for any reason, the entire string of production equipment would necessarily be pulled to get at the transmission for repairs or replacement, at an inordinate cost in time and dollars. Reliability, therefore, becomes extremely important, and greatly enhanced construction and assembly is the result. These are just some of the factors which are in play for which the present invention was created.

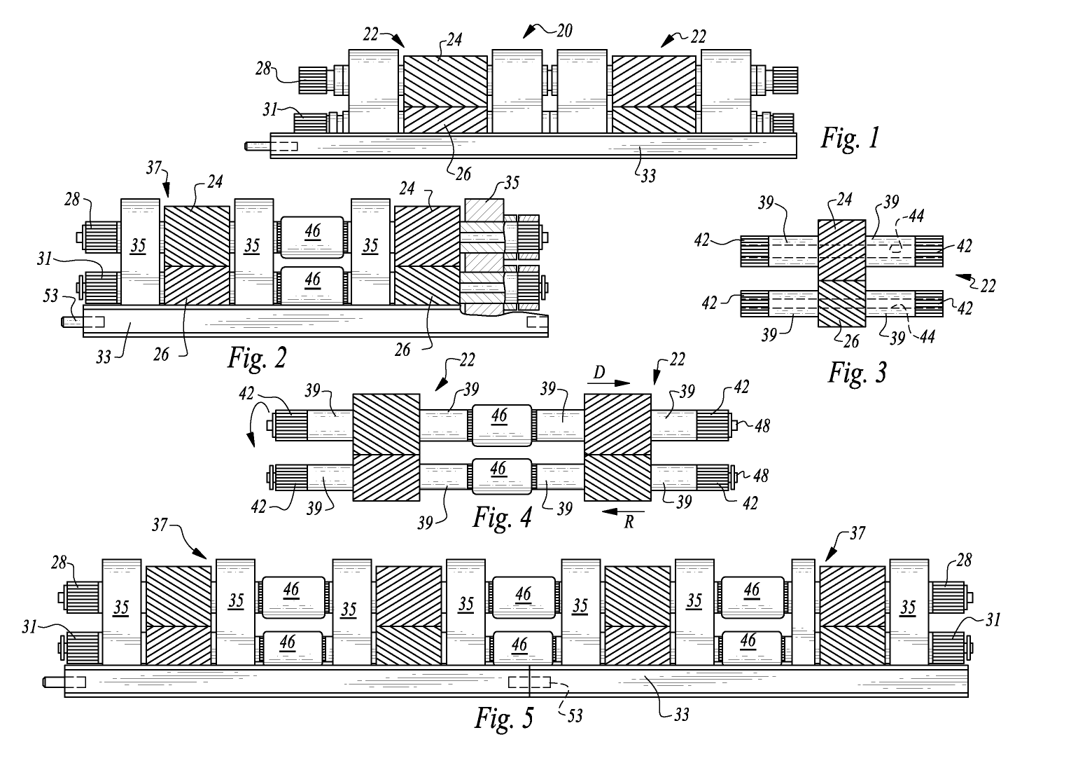

Turning now to the drawing, and initially to FIG. 1, the essence of any transmission is the internal gearing which receives, and transmits, power, and so, too, it is with the present invention. In existing transmissions engineered to operate in this environment, a unitary gear set having as many as eight, and sometimes more, pairs of meshed helical gears, mounted on parallel driving and driven shafts, currently share the power from the power source, transmitting that power to the driven instrument at the base of the drill string.

Size constraints and, in particular, the diameter of the casing in which the transmission must operate, dictate that each gear be rather small, which may be compensated for by increasing the number of gears on a shaft. However, merely stacking gear pairs on a very long drive or driven shaft is somewhere between impractical and ineffective. Primarily, construction of such a gear train adds substantially to cost and difficulty in manufacture. Rather than creating the problems just enumerated, the present invention suggests that by building modular gear trains and connecting them in driving relation, performance can be achieved while problems in construction and manufacture are avoided, or at least minimized.

The present invention contemplates at least two distinct forms of modular gear sets, and, with reference still to FIG. 1, a pictorial representation is provided of one such form of modular gear set which, when combined with like modules, is effective in facilitating the objectives of the present invention. In keeping with the invention, a modular gear set 20 is shown and includes serially spaced helical gear pairs 22. Each gear pair includes a helical drive gear 24 enmeshed with a helical driven gear 26. A drive shaft 28 and a parallel driven shaft 24 are provided to support, rotate and help maintain alignment of the gears of each pair.

It is essential that intermeshed gear pairs 22 be even in number, in the same ratio, and that those gear pairs be axially aligned, thus substantially identical. Further, alignment must be substantially maintained while the gear pairs are under load, which creates a potential problem due to the tendency of helical gears to move axially under load.

In order to ensure stability and proper alignment when multiple modules are called for, a base plate 26 is provided and mounted thereto are several upstanding bearing blocks 28 which cradle and support the gears via the stub shaft bearing journals, 39, on the ends of each of the gears. With the bearing blocks 28 initially fixed on the base plate, it will be apparent that, as the length of the shafts is increased, the task of aligning the bearing bores for the positioning of bearings in those blocks takes special tooling, and a steady hand is vital and the margin for error slight. The alignment problem is exacerbated by the fact that, in most cases, the base plate and bearing block assembly is so long that the bearing bores must be formed in the bearing blocks before mounting of the blocks to the base plate.

In further keeping with the present invention, problems such as those discussed are capable of being efficiently resolved by employing a modular gear train construction comprised of modules having shorter drive driven shafts and offering uniformity of design, gear ratios and construction and the ability to be interconnected to provide a gear train having the capacity needed for any particular task. Further, each module is short enough so that the bearing bores can be formed while the bearing blocks are affixed to the base plate, allowing great bearing alignment accuracy as required for reliable, long term operation of the transmission.

Referring to FIG. 2, a representative illustration of a gear train is exemplified by a pair of like modules 20, that have been serially coupled in driving relation. It will be appreciated that additional modules may be added to this gear train as needed to meet the power needs of the tool to which it is in driving engagement at the end of the string.

FIG. 4 is presented in order to permit a clear view of the structure of the gearing in the module of FIG. 1 and, more particularly, to provide those skilled in the art with a better understanding of the gear movement which results from the use of helical gearing.

As may be seen there, two gear pairs 22 are provided and joined by a coupler 46. The coupler is formed with an internal spline which engages the tips of the splined tips 42 of the stub shafts 39. As the drive shaft 28 is rotated in a clockwise direction by the power source to which it is coupled in driving engagement, it will be seen that the drive gear tends to move in the direction of the arrow D, causing the driven gear to move in the direction of arrow R.

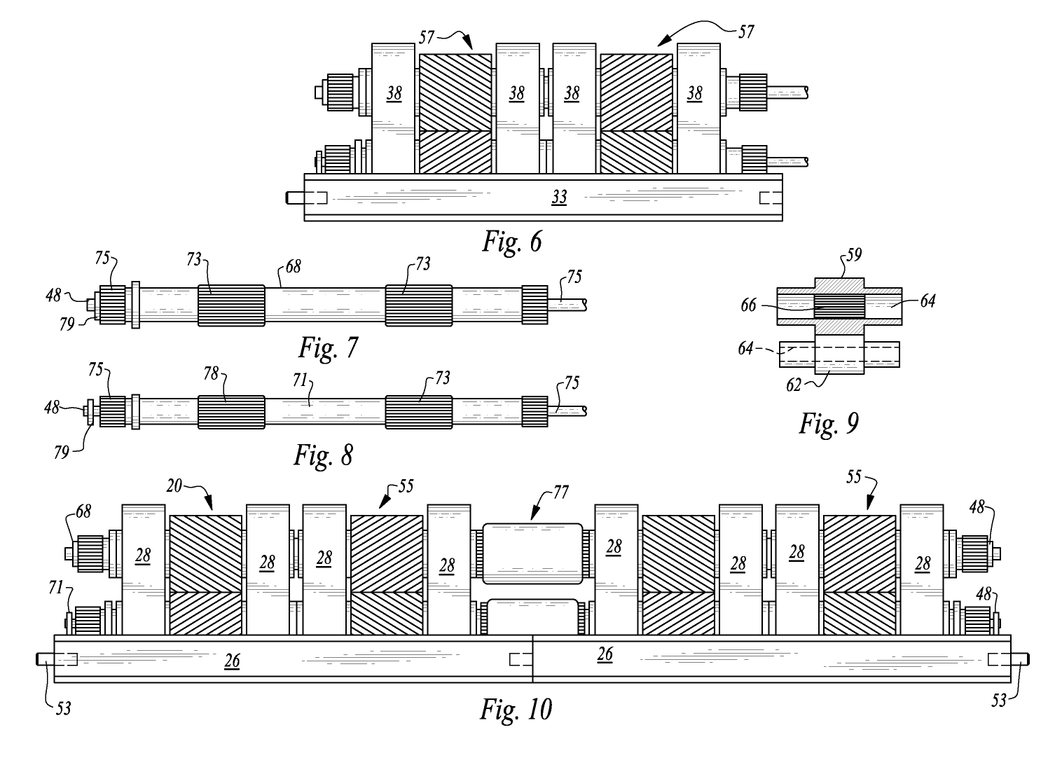

FIG. 6 represents yet another modular gear set configuration having the proclivity to deliver, in concert with other like gear sets, the objects set out for the transmission of the present invention.

Thus, a modular gear set 37, in which each gear of a helical gear pair 22 is formed with axial extensions, as distinguished from the drive and driven shafts of FIG. 1. Unlike the gear set 20, more specifically, flanking stub shafts 39 [best seen in FIG. 3] are provided. Each stub shaft 39 is formed with splines 42 at the free ends thereof. It will also be observed that each gear 24, 26 and its attendant stub shafts 39 is formed with a central bore 44. The purpose of these structural features will soon become apparent.

Moving now to FIG. 4, in concert with FIG. 2, the interrelationship of the various elements of the gear train can be recognized, and their ability to achieve the goals of the present invention will become clear.

It will be appreciated, as taught by Morrow, that power sharing is created by this arrangement, but in the course of sharing, the gears 24 and 46 will necessarily move laterally as power is applied to the drive gear 24. In order to control the extent of movement of the gears, tension rails 48 are inserted through the central bores 44, along the axis of rotation of the gears, with their termini extending beyond the ends of the stub shafts 39 and retainers 51, e.g., slip rings, although other fasteners may serve the purpose without departure from the invention.

Still referring to FIG. 4, a series of directional arrows guide those skilled in the art in understanding the movement of the gearing and is demonstrated from the standpoint of a power source providing input to the drive gears in a counterclockwise direction. Specifically, the drive gears 24 in the FIG. 4 example will tend to move away from one another, whereas the driven gears 26 tend to move toward one another with a resultant balance of loading on the system.

In keeping with the objectives of the invention, the system exemplified in FIGS. 2, 3 and 4 is expandable to accommodate the need for more power at the end of the string, as needed. In Morrow '147 patent it was learned that by adding even numbers of gear sets it was possible to greatly magnify the power transmitting the capacity of the gear set. By using an even number of gear pairs, the added expense of thrust bearings is eliminated. Indeed, by upgrading a four gear set to a six gear pair set, the load transmitting capability is increased by as much as 50%.

Applying that understanding, and with reference to FIG. 5, but one example of how the concept can be put to practical use is illustrated.

Referring to FIG. 5, a pair of gear sets 37 are joined to form a two-stage gear set, combining two of the modular gear sets depicted in FIG. 2. Thus, two such modular gear sets 27 are combined to their respective base plates 33 and coupled together with couplers 46. In order to stabilize the base plates, an alignment pin 53 is provided which is fitted into appropriate apertures in the base plates to ensure appropriate alignment and stability of the gear set under load. As is the case with FIG. 2, modular unit 37, the drive shafts 28 are coupled, as are the drive shafts 31, to complete the power circuit through the transmission.

It will be appreciated that additional modular units such as unit 37 having two gear pairs may be added to the gear set shown in FIG. 5, so long as even numbers of gear sets are provided, with a resultant load sharing transmission having a capacity which is commensurate with the number of gear pairs combined in the gear set.

The module gear set 20 is but one example of an operative gear set within the contemplation of the invention. With reference to FIG. 6, another such example is illustrated. A modular gear set 55 rests on a base plate 33 and comprises two serially spaced gear pairs 57. Each gear pair 57 is comprised of a driving gear 59 and a driven gear 62. Moving to FIG. 9, each gear 59, 62 is shown in considerable detail. It will be seen that every gear is formed, or otherwise provided, with an axial bore 64, and within the axial bore of each is provided an internal spline 66, transversely aligned with the helical gear itself.

Referring next to FIGS. 7 and 8, a driving shaft 68 and driven shaft 71, respectively, are illustrated. Each of the shafts has spaced splines 73 formed or otherwise provided thereon. The splines 73 are positioned to engage the interior splines 66 of each gear in driving relation when the shafts are inserted into the gears as seen in FIG. 6. Additionally, the remote ends of each shaft are splined at 75 to thereby permit driving engagement with a power source to one end thereof and either another gear set or a tool at the other.

Reference is next made to FIG. 10, where a pair of gear sets 55 have been coupled in driving engagement. Thus, a splined coupler 77 is interposed between adjacent driving and adjacent driven shafts, thereby creating a direct positive driving connection between coupled shafts.

Finally, it will be recalled that the gears, by virtue of their position as engaged on splines, are movable axially in response to the axial forces created by the helical teeth on the gears. While that movement is the genesis of power sharing, the distance moved must be controlled. For that purpose tension rails 48 are centrally disposed in the driving and driven shafts and are of greater length than those shafts. As a result, they protrude beyond the driving and driven shafts and fasteners, such as, e.g., snap rings 79 are fitted on the tension rails to limit gear movement.

Having now described, in considerable detail, an improved multi-stage system for modular transmissions, it is appreciated that those skilled in the art will be able to think of variations on the elements described. Such variations are within the contemplation of the invention as defined by the accompanying claims, wherein:

1. A multi-stage modular transmission for transmitting rotational power from a power source to a down hole tool, comprising, in combination:
at least one pair of modular gear sets;
each said modular gear set including an even number of gear pairs serially spaced and in driving engagement; one of said gears being a drive year; said drive gear being meshed with a drive gear to thereby form said gear pair,
a coupler, said coupler serially engaging adjacent gear pairs.

2. The multi-stage modular transmission of claim 1, wherein said gear pairs are supported on a base plate so as to restrain said gear sets from relative movement.

3. The multi-stage modular transmission of claim 1, wherein said base plate is provided with serially spaced bearing blocks, said bearing blocks supporting each of said gear pairs in axially alignment.

4. The multi-stage modular transmission of claim 2, wherein said base plate is provided with serially spaced bearing blocks, said bearing blocks supporting each of said gear pairs in axially alignment.

5. The multi-stage modular transmission of claim 1, wherein said base plate is provided with serially spaced bearing blocks, said bearing blocks supporting each of said gear pairs in axially alignment.

6. The multi-stage modular transmission of claim 1, wherein said modular gear sets are substantially identical.

7. The multi-stage modular transmission of claim 6, wherein each said gear in a said gear pair having stub shafts, said stub shafts being axially aligned and disposed on either side of said gear, said stub shafts extending along the longitudinal axis of rotation of said gear and being coupled to adjacent stub shafts in driving engagement.

8. The multi-stage modular transmission of claim 6, wherein said gear pairs are provided with an axial bore, said bore having internal gear teeth therein; a drive shaft disposed in the said axial bore in said driving gears and extending beyond the terminus of said each modular gear set; a driven shaft disposed in the axial bore of said driven gears and extending beyond the terminus of said modular gear set.

9. A multi-stage modular transmission for transmitting rotational power from a power source to a down hole tool comprising, in combination:
at least a pair of modular helical gear sets, each of said modular helical gear sets including drive gears and driven gears, said drive gears intermeshed with said driven gears, said drive shafts being in driving engagement with the said drive shafts of an adjacent modular gear set and coupled to a power source, said driven shafts being in driving engagement to an adjacent driven shaft and being in driving engagement with a down hole tool; a tension rail; said tension rail positioned along the axis of rotation of each of said driving and driven shaft gears.

10. The multi-state modular transmission of claim 9, wherein said gear pairs are supported on a base plate, so as to restrain said gear sets from relative movement.

11. The multi-stage modular transmission of claim 9, wherein said base plate is provided with serially spaced bearing blocks, said bearing blocks supporting each of said gear pairs in axially alignment.

12. The multi-stage modular transmission of claim 9, wherein said modular gear sets are substantially identical.
